(19) United States
(12) Patent Application Publication
(10) Pub. No.: US 2005/0166518 A1
(43) Pub. Date: Aug. 4, 2005

(54) Concrete stone

(76) Inventor: Luc Anna Philomena Van Cauwenbergh, Duffel (BE)

Correspondence Address: BACON & THOMAS, PLLC, 625 SLATERS LANE, FOURTH FLOOR, ALEXANDRIA, VA, 22314, US

(21) Appl. No.: 10/504,846

(22) PCT Filed: Feb. 27, 2003
(86) PCT No.: PCT/BE03/00034

(30) Foreign Application Priority Data
Mar. 8, 2002 (BE) 2002/0158

(51) Int. Cl. B28B 1/16; B28B 7/00

(52) U.S. Cl. 52/596; 264/256; 264/313

(57) ABSTRACT

Concrete stone, characterised in that it at least consists of two layers of concrete (3-4), whereby one of these layers (3-4) forms a top layer (3) and whereby at least these two layers (3-4) are made of hardened liquid concrete (6-7).

The present invention concerns a concrete stone.

In particular, it concerns concrete stones of the block-shaped type, in other words concrete stones having a relatively large thickness in relation to the dimensions of their top side, implying concrete stones which can be used, as is known, for pavements, drives, terraces and the like, as well as concrete stones used for walls and partition walls.

It is known that such concrete stones are usually made of a relatively dry type of concrete. To this aim, said concrete is provided in a rigid mould and pressed by means of a press and vibration device.

It is also known to manufacture concrete flooring tiles, which are relatively thin in relation to the dimensions of their surface, of two layers of a different mortar on the basis of cement. The top layer is hereby formed of a fine-grained, rather liquid and usually coloured mortar, while the bottom layer consists of a relatively dry concrete. When such concrete flooring tiles are formed, the mortar is first provided in a mould, after which the relatively dry or slightly damp concrete is put on the mortar. As the slightly damp concrete forms a coherent mass so to say, it remains lying on the rather liquid mortar, after which the whole can be pressed and vibrated.

The invention aims a new construction of a concrete stone, offering new possibilities in relation to the known techniques. To this end, the object of the invention consists of a concrete stone which is characterised in that it consists of at least two layers of concrete, whereby one of these layers forms a top layer and whereby at least these two layers are made of hardened liquid concrete.

According to the invention, by liquid concrete should be understood concrete which automatically spreads rather well when poured in a mould, as opposed to the slightly damp concrete types which are traditionally used to form pavement tiles. For the craftsman, it will be clear when a liquid concrete type is meant on the one hand, and a ‘dry’ or ‘slightly damp’ concrete type is meant on the other hand. Preferably, however, by a liquid concrete should be understood a concrete meeting certain criteria, which will be further defined and illustrated in the following detailed description.

By way of illustration is mentioned that the liquid concrete in question is sometimes also referred to as cast concrete or poured concrete, whereas the slightly damp concrete is also called pressed concrete.

Moreover, in the hardened condition, we can usually make a distinction between the two concrete types. A technique which normally enables us to make such distinction consists in the use of a slice and petrographic techniques: the structure of cast concrete is characterised by flow structures and mainly round pores, whereas slightly damp, pressed concrete is characterised by predominantly elongated pores, ducts and a more laminated structure.

By making use of two or more layers formed of liquid concrete, different advantages are obtained, and this also offers new possibilities for the realisation of special concrete stones.

A first advantage consists in that, as the two types of concrete make contact in a very liquid state during the formation of the concrete stone, the concrete types so to say overflow in their contact zone, whereby, after the hardening, there is a solid setting between both layers.

A second advantage consists in that, on the one hand, concrete stones can be made whereby the base is made of less expensive concrete, whereas the top layer is formed of a better concrete type, while the possibility nevertheless remains to form the concrete stones in flexible moulds, for example made of rubber. When liquid concrete is used, the pressing can take place without much force being used, so that pressure-resistant moulds are not required. The use of flexible moulds makes it possible to produce concrete stones in special shapes. Such flexible moulds allow for the realisation of irregular forms, for example, as well as concrete stones whose base is narrower than the top surface, for example, concrete stones whose perimeter is provided with undercuts, etc., while the concrete stones can still be taken out of their moulds without any problems once they have hardened.

Preferably, at least the top layer and the layer situated immediately underneath it are made of liquid concrete. In particular, the concrete stone is preferably exclusively made of the above-mentioned two layers, in other words it is formed exclusively of a top layer and a base layer situated underneath it.

The top layer can have several thicknesses, but it is preferably in the order of magnitude of 1 to 2 cm, which offers the advantage that it is sufficiently thick to prevent the concrete of the bottom layer from penetrating through the top layer while these concrete stones are being cast on the one hand, while it is not needlessly thick, which would make the cost price of the concrete stones unnecessarily rise due to the fact that the top layer is normally formed of a more expensive type of concrete. However, this does not exclude other possible thicknesses.

The concrete stone may have a regular as well as an irregular shape. By an irregular shape is meant, for example, that the top surface is uneven. Such an uneven surface is obtained by making use of moulds whose bottom is not flat. When slightly damp concrete is used in this case, it becomes particularly difficult to press the concrete into every spot on the bottom with certainty and to obtain a precise, minute rendering of the original texture. However, by making use of liquid concrete according to the invention, the concrete will automatically spread in every spot on the bottom, possibly assisted by a vibrating action, irrespective of its shape.

The above-mentioned top layer is preferably made of fine-grained concrete, also called mortar, in other words formed of a substance whose maximum grain size is smaller than 4 mm, or least predominantly smaller than 4 mm, by which is meant that no or hardly any grain-shaped or granulated substances larger than 4 mm are found in the concrete.

However, at least one or several of the layers which do not serve as a top layer are preferably formed of concrete with substances including among others grains with grain sizes larger than 4 mm.

It is clear that the top layer may possibly be coloured and/or may contain granules.

The invention also concerns a method for manufacturing such concrete stone, characterised in that it is formed in a mould in which is first cast the concrete to form the top layer and then, while the concrete of the top layer is still fluid, the concrete of the next layer is provided in it.

In order to better explain the characteristics of the invention, some preferred embodiments according to the invention are described as an example only without being limitative in any way, with reference to the accompanying drawings, in which:

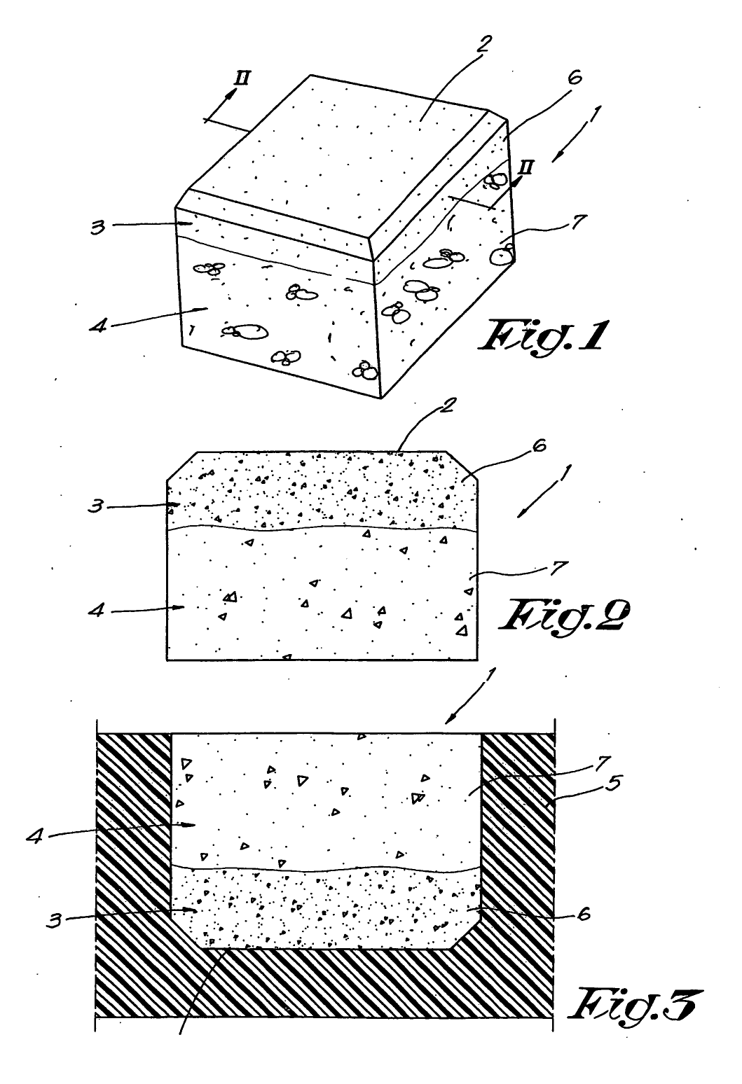

FIG. 1 is a view in perspective of a concrete stone according to the invention;

FIG. 2 represents a section according to line II-II in FIG. 1;

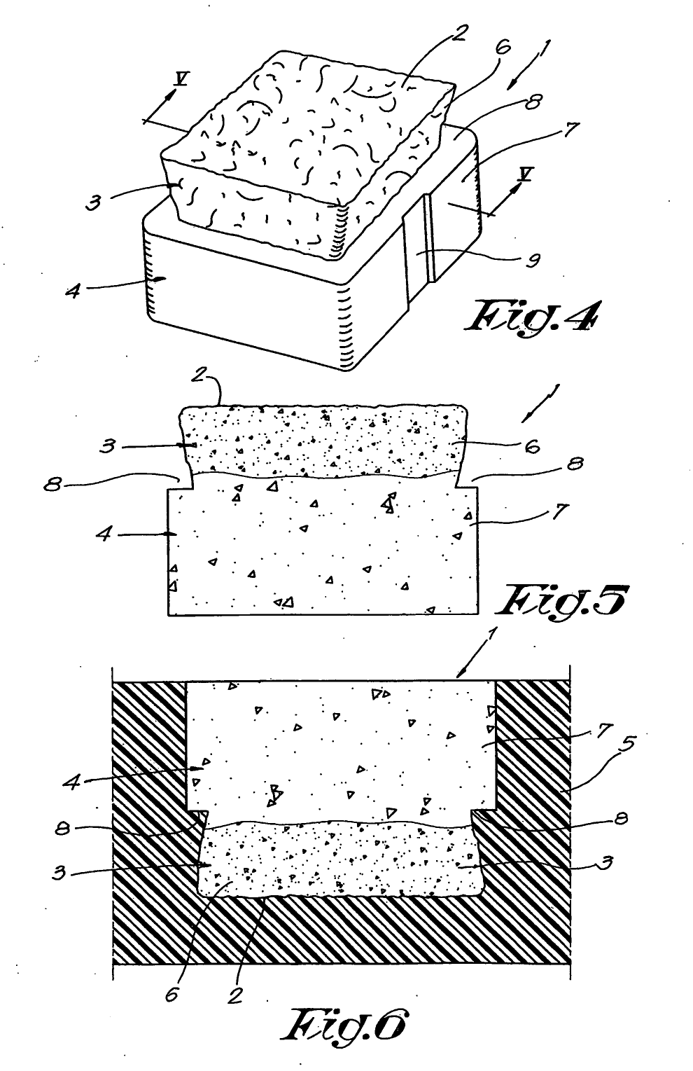

FIG. 3 shows how this concrete stone from FIG. 1 can be manufactured;

FIG. 4 shows another concrete stone according to the invention;

FIG. 5 shows another section according to line V-V in FIG. 4;

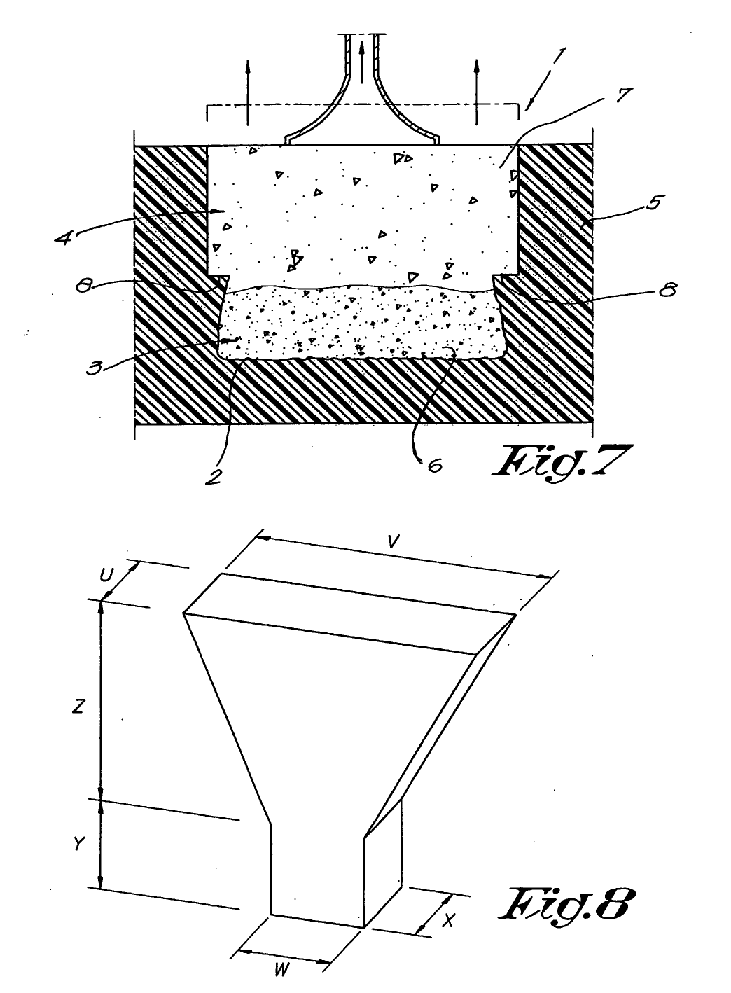

FIGS. 6 and 7 represent for two different steps how the concrete stone from FIGS. 4 and 5 can be made;

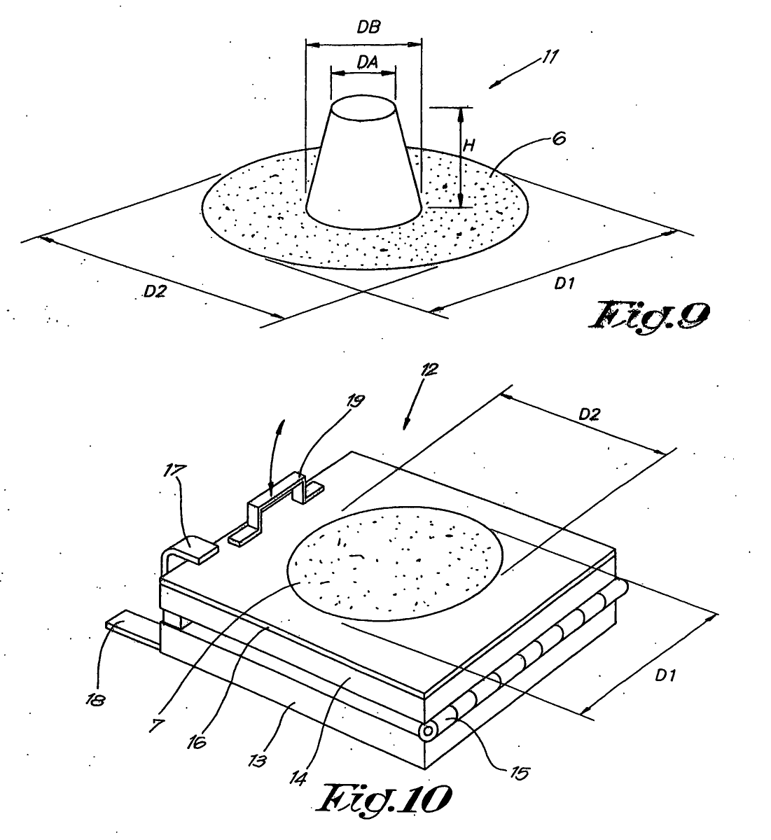

FIGS. 8, 9 and 10 schematically represent a number of test arrangements known as such for determining the liquidity of concrete.

As is represented in FIGS. 1 and 2, the invention concerns a concrete stone 1 which is preferably of the block-shaped type, in particular a pavement tile or what is called a concrete paving block.

In the embodiment from FIGS. 1 and 2, the concrete stone 1 has a simple, prismatic shape and a smooth top surface 2, but, as will be illustrated hereafter, such a concrete stone 1 can also be realised in other shapes.

As is represented in particular in the section of FIG. 2, the concrete stone 1 is characterised in that it is made of at least two, and preferably exactly two layers of concrete 3-4, both of which are made of hardened ‘liquid concrete’, as opposed to the ‘dry concrete’ that was usually used until now. These layers 3-4 form a top layer on the one hand, hereafter also indicated with reference FIG. 3, and a base layer situated underneath it on the other hand, hereafter also indicated with reference FIG. 4. The concrete types used to this end preferably have liquidity characteristics, as will be further explained. As far as the composition is concerned, their characteristics are preferably as defined in the introduction.

As represented in FIG. 3, the concrete stones 1 are preferably formed in a flexible mould 5, for example made of rubber or plastic. The concrete 6 to form the top layer 3 is first cast or provided in the bottom of the mould 5. While the concrete 6 is still fluid, the concrete 7 to form the base layer 4 is cast or put on the concrete 6.

When all the concrete 6-7 has sufficiently hardened, the thus obtained concrete stone 1 is taken out of the mould 5.

FIGS. 4 and 5 represent a variant of a concrete stone 1 according to the invention having a number of special characteristics of shape, such as the fact that it has an irregular shaped top surface 2, a groove-shaped tapered recess 8 over its perimeter, in the shape of an undercut, to form a joint, and recesses 9 to form a passage for water.

FIG. 6 represents in a manner analogous to that of FIG. 3 how the concrete stone 1 from FIGS. 4 and 5 can be realised in a flexible mould 5. As the concrete stone 1 is entirely made of ‘liquid concrete’, it is not necessary to press on the concrete 6-7 with much force and, consequently, it is not necessary either to use a rigid mould. The use of the flexible mould 5 and the fact that the concrete stone 1 is made of several layers of liquid concrete 3-4 offers the advantage that concrete stones 1 consisting of several layers can be made, with a shape which can normally not be realised in a simple, one-piece, rigid mould.

The flexible mould 5 makes it possible, thanks to the flexible nature of the material of which it is made, to take a concrete stone 1 having any shape whatsoever out of said mould 5 as soon as the concrete 6-7 has hardened, for example to pull it out of it as is represented in FIG. 7 for the concrete stone 1 from FIGS. 4 and 5.

Naturally, the use of rigid, either or not multipart moulds is not excluded according to the invention.

The concrete 6 and the concrete 7 preferably meet certain criteria as far as liquidity is concerned, determined by means of generally known tests for measuring the liquidity. These tests, as well as the criteria applied to the concrete 6 and 7, are briefly illustrated hereafter.

For the concrete 6 of the top layer 3, use is preferably made of a concrete type whose degree of liquidity meets specific criteria, defined by means of what is called the funnel test for mortar and/or the test with what is called the Abram's cone and/or what is called the spread test.

The funnel test makes use of a funnel 10 with a shape as is represented in FIG. 8 and with dimensions U=30 mm, V=270 mm, W=30 mm, X=30 mm, Y=60 mm and Z=240 mm. These are the funnel dimensions applied to the ‘funnel test for mortar’. The concrete 6 is fine-grained and in fact forms a mortar, so that the ‘funnel test for mortar’ has to be applied instead of the ‘funnel test for concrete’, whereby other funnel dimensions apply.

The test itself consists in that the funnel 10 is entirely filled with the concrete 6 concerned, while this funnel 10 is sealed at the bottom, after which the funnel 10 is opened at the bottom and the outflow time serves as criterion for the liquidity of the concrete 6.

The concrete 6 preferably has such a liquidity that, according to the funnel test for mortar, an outflow time of 5 to 15 seconds is required, and according to the most preferred embodiment, an outflow time in the order of magnitude of 10 seconds is required.

The test with the Abram's cone, as is schematically represented in FIG. 9, makes use of a truncate cone 11 which is open at the top and at the bottom, and which has the following dimensions: DA=100 mm, DB=200 mm and H=300 mm.

The test consists in that the Abram's cone is erected on a base and is filled with the concrete 6, after which the cone 11 is lifted, such that the concrete 6, as is schematically represented in FIG. 9, spreads over the base. The average diameter over which the concrete 6 spreads is then a measure for the liquidity. This average diameter is the average of the diameters D1 and D2 indicated in FIG. 9.

The concrete 6 preferably has such a liquidity that, during the test with the Abram's cone, a spread of 65 to 80 cm is obtained, and according to the most preferred embodiment, a spread in the order of magnitude of 70 cm.

What is called the ‘spread test’ applies the same method as the test with the Abram's cone, but it uses a small version of a cone, namely having dimensions DA=70 mm, DB=100 mm and H=60 mm.

The concrete 6 preferably has such a liquidity that a spread of 20 to 30 cm is obtained during this ‘spread test’, and according to the most preferred embodiment, a spread in the order of magnitude of 24.5 cm.

For the concrete 7 of the base layer 4, use is preferably made of a type of concrete whose liquidity degree meets specific criteria, defined by means of a test on what is called a shock table according to standard NBN B15-205.

Two types of standard shock tables can be used for the test with a shock table.

For the shock table of type I, use is made of a steelplate retaining its shape and having a diameter of 800 mm, equipped with a vertical rod. By means of a lever connected to a cam, it is possible to give shocks to said plate by lifting it by means of the cam and by each time dropping it again, which shocks correspond to a free fall over 15 mm.

On this shock table is spread an amount of concrete, starting from a mould filled with this concrete which is more or less the same as the Abram's cone, but having dimensions DA=200 mm, DB=300 mm and H=150 mm.

The table then receives 15 shocks in about 15 seconds thanks to a regular movement via the cam. The average diameter of the spread concrete will then form a measure for the liquidity of the concrete 7. This average diameter is the average of two perpendicular diameters of the spread concrete mass.

The shock table 12 of type II consists, as is represented in FIG. 10, of two wooden frames 13-14 of 700×700 mm placed on top of one another, which can rotate around the common side by means of a hinge 15. The top frame 14 is covered with a steelplate 16 having a thickness of 2 mm and weighing 16 kg. A stop 17 is fixed on the lower frame 13 and along the side opposite to the hinge 15, which limits the lifting of the top frame 14 to 35 mm, as well as one or several supports 18 upon which the user can place his feet in order to prevent the lower frame 13 from moving. The top frame 14 is also equipped with a handle 19 on the opposite side of the hinge 15.

When using the shock table 12, the shocks are generated by lifting the top frame 14 with the handle 19 up to the stop 17 and by subsequently letting the frame 14 drop. This is also repeated 15 times in a period of about 15 seconds. The average of the represented diameters D1 and D2 then forms a measure for the liquidity of the concrete 7.

The concrete 7 preferably has such a liquidity that, during a test with such a shock table, either of type I or of type II, an average spread diameter of 55 to 65 cm is obtained, and according to the most preferred embodiment a spread in the order of magnitude of 60 cm.

It is clear that the invention is not limited to rectangular concrete stones, but also applies to concrete stones in all sorts of shapes, i.e. also concrete stones which have a bent shape when seen from above, which are key-shaped, etc.

It is clear that, since the concrete stone according to the invention is designed as a stone for realising walls or partition walls, by ‘top layer’ or upper layer should be understood the layer situated on the side of the stone, in particular the side designed to form the visible side when realising a wall or a partition wall. Nor is it excluded, in the case of such stones, to provide the concrete type which is qualitatively better on more than two sides of the concrete stone.

The invention is by no means limited to the above-described embodiments represented in the accompanying drawings; on the contrary, such concrete stones as well as the method for their realisation, can be made in all sorts of variants while still remaining within the scope of the invention.

1. Concrete stone, comprising two layers of concrete (3-4), wherein one of these layers (3-4) forms a top layer (3) and wherein at least these two layers (3-4) are made of hardened liquid concrete (6-7), wherein the concrete of the top layer (3) is at least liquid to such a degree, that when the concrete stone (1) is being cast, it meets one or several of the following criteria:
that this liquid concrete (6), when being subjected to what is called the funnel test for mortar, requires an outflow time of 15 seconds or less;
that this liquid concrete (6), when being subjected to a test with what is called the Abram's cone, having a diameter of 100 mm at the top, a diameter of 200 mm at the bottom and a height of 300 mm, has a spread of at least 65 cm;
that this liquid concrete (6), when being subjected to a spread test, with a cone having a diameter of 70 mm at the top, a diameter of 100 mm at the bottom and a height of 60 mm, has a spread of at least 20 cm.

2. Concrete stone according to claim 1, wherein at least the top layer (3), as well as the layer (4) situated immediately underneath it, are formed of liquid concrete (6-7).

3. Concrete stone according to claim 1, wherein it is exclusively formed of the above-mentioned two layers (3-4).

4. Concrete stone according to claim 1, wherein it is made as a pavement tile or a stone for building walls or partition walls.

5. Concrete stone according to claim 1, wherein it has an irregular shape.

6. Concrete stone according to claim 1, wherein the above-mentioned top layer (3) is made of fine-grained concrete (6), also called mortar, formed of substances whose maximum grain size is smaller than, or is at least predominantly smaller than 4 mm.

7. Concrete stone according to claim 1, wherein at least one or several of the layers (4) which do not serve as a top layer (3) are formed of concrete (7) comprising grains or granulates having a grain size which is larger than 4 mm.

8. Concrete stone according to claim 1, wherien the top layer (3) is formed of hardened liquid concrete (6), which is at least liquid to such a degree that when the concrete stone (1) is being cast, it meets one or several of the following criteria:
that this liquid concrete (6), when being subjected to what is called the funnel test for mortar, requires an outflow time of 5 seconds or more;
that this liquid concrete (6), when being subjected to a test with that is called the Abram's cone, having a diameter of 100 mm at the top, a diameter of 200 mm at the bottom and a height of 300 mm, has a spread of maximum 80 cm;
that this liquid concrete (61), when being subjected to a spread test, with a cone having a diameter of 70 mm at the top, a diameter of 100 mm at the bottom and a height of 60 mm, has a spread of at least 30 cm.

9. Concrete stone according to claim 1, wherein the top layer (3) is formed of hardened liquid concrete (6), which is at least liquid to such a degree that when the concrete stone (1) is being cast, it meets one or several of the following criteria:
that this liquid concrete (6), when being subjected to what is called the funnel test for mortar, requires an outflow time in the order of magnitude of 10 seconds;
that this liquid concrete (6), when being subjected to a test with what is called the Abram's cone, having a diameter of 100 mm at the top, a diameter of 200 mm at the bottom and a height of 300 mm, has a spread in the order of magnitude of 70 cm;
that this liquid concrete (6), when being subjected to a spread test, with a cone having a diameter of 70 mm at the top, a diameter of 100 mm at the bottom and a height of 60 mm, has a spread in the order of magnitude of 24, 5 cm.

10. Concrete stone according to claim 1, wherein the layer (4), or at least one of the layers respectively, which are formed of hardened liquid concrete (7) but are nevertheless different from the top layer (3), is at least liquid to such a degree that when the concrete stone (1) is being cast, that this concrete (7) meets one or several of the following criteria:
that during a test with a shock table NBN B15-205, preferably of what is called type I, a minimum spread of 55 cm is obtained;
that during a test with a shock table NBN B15-205, preferably of what is called type I, a maximum spread of 65 cm is obtained;
that during a test with a shock table NBN B15-205, preferably of what is called type I, a spread in the order of magnitude of 60 cm is obtained.

11. Concrete stone according to claim 1, wherein it is formed of hardened concrete (6-7), whereby the above-mentioned two layers (3-4) of liquid concrete (6-7) are poured onto one another in a liquid state.

12. Method for realising a concrete stone (1) according to claim 1, wherein it is formed in a mould (5) in which the concrete (6) is first cast for forming the top layer (3) and next, while the concrete (6) of the top layer (3) is still liquid, the concrete (7) of the subsequent layer (4) is cast.

13. Method according to claim 12, wherein the concrete stone (1) is cast in a rigid or flexible mould (5) which is either or not deformable.
